(19) United States
(12) Patent Application Publication
(10) Pub. No.: US 2026/0299286 A1
(43) Pub. Date: Oct. 1, 2026

(54) CAMERA MODULE

(71) Applicant: Samsung Electro-Mechanics Co., Ltd., Suwon-si (KR)

(72) Inventors: Dooseub SHIN, Suwon-si (KR); Jung Hyun PARK, Suwon-si (KR); Namkeun OH, Suwon-si (KR); Sanghyun JI, Suwon-si (KR)

(73) Assignee: Samsung Electro-Mechanics Co., Ltd., Suwon-si (KR)

(21) Appl. No.: 19/295,299

(22) Filed: Aug. 8, 2025

(30) Foreign Application Priority Data
Apr. 1, 2025 (KR) 10-2025-0042011

(51) Int. Cl. G02B 27/00; H04N 23/55

(52) U.S. Cl. CPC G02B 27/0006; H04N 23/55

(57) ABSTRACT

A camera module includes a lens barrel; a wiper disposed in a region in which light is incident toward the lens barrel; a supporter connected to the wiper; and a driving module configured to provide power to rotate the supporter, wherein the driving module includes a driving member having a magnetic property and including a part inserted into the supporter and being slidingly movable relative to the supporter; and a coil configured to generate a magnetic field to move the driving member.

### CROSS-REFERENCE TO RELATED APPLICATIONS

This application claims the benefit under 35 USC 119(a) of Korean Patent Application No. 10-2025-0042011 filed on Apr. 1, 2025, in the Korean Intellectual Property Office, the entire disclosure of which is incorporated herein by reference for all purposes.

### BACKGROUND

### 1. Field

The present disclosure relates to a camera module.

### 2. Description of the Background

A camera module may be installed in a smartphone, a laptop computer, a vehicle, or other apparatus. For effective operation of the camera module, external light needs to enter the camera module without interference. However, during use, a foreign substance may adhere to an area where light enters the camera module, and such a foreign substance may interfere with the light entering the camera module.

Accordingly, a camera module capable of removing a foreign substance attached to an area where light is incident is desirable.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens barrel; a wiper disposed in a region in which light is incident toward the lens barrel; a supporter connected to the wiper; and a driving module configured to provide power to rotate the supporter, wherein the driving module includes a driving member having a magnetic property and including a part inserted into the supporter and being slidingly movable relative to the supporter; and a coil configured to generate a magnetic field to move the driving member.

A sliding hole having a predetermined length may be formed in the supporter in a length direction of the supporter, and the driving member may include a magnetic member including an N-pole region and an S-pole region; and a guide pin connected to the magnetic member, inserted into the coil and the sliding hole, and being slidingly movable in the sliding hole relative to the supporter.

The coil may be disposed at a fixed position relative to the lens barrel.

The camera module may further include a carrier accommodating the lens barrel.

The driving module may further include a yoke connected to the carrier and configured to generate a magnetic attraction with the driving member.

The camera module may further include at least one ball bearing disposed between the carrier and the driving member.

An outer guide groove may be formed in the carrier, and the at least one ball bearing may be disposed in the outer guide groove.

An inner guide groove may be formed in the driving member, and the at least one ball bearing may be disposed in the inner guide groove.

The camera module may further include a voltage application line connected to the wiper.

An inner surface of the wiper facing the lens barrel may have hydrophilicity.

An inner surface of the wiper facing the lens barrel may have a protrusions and depressions structure.

A cleaning fluid path may be formed in the wiper, and a fluid discharge hole connected to the cleaning fluid path may be formed in an inner surface of the wiper facing the lens barrel.

The wiper may include a transparent material.

The camera module may further include a light incident member of which at least a portion is disposed above an upper end of the lens barrel, wherein the wiper does not contact the light incident member.

Other features and aspects will be apparent from the following detailed description, the drawings, and the claims.

### BRIEF DESCRIPTION OF DRAWINGS

FIG. 1 shows a camera module according to an embodiment.

FIG. 2 is a longitudinal cross-sectional view of a light incident member and a wiper of FIG. 1.

FIG. 3 is a longitudinal cross-sectional view of a central area in a vertical direction of the camera module of FIG. 1.

FIG. 4 shows a driving module and a first supporter of FIG. 3 viewed toward a lens barrel.

FIG. 5 shows an outer surface of a carrier in a region where the driving module is disposed viewed toward the lens barrel.

FIG. 6 shows an inner surface of a driving member facing the outer surface of the carrier 20 shown in FIG. 5.

FIG. 7 and FIG. 8 show operation states of the driving module.

FIG. 9 is a cross-sectional view of a wiper according to another embodiment.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The use of the term “may” with respect to an example or embodiment, e.g., as to what an example or embodiment may include or implement, means that at least one example or embodiment exists in which such a feature is included or implemented, while all examples and embodiments are not necessarily limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween, or the elements may be physically connected as well as electrically connected, or the elements may be integral despite being referred to by different names according to position or function. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Also, throughout the specification, “plan view” means that the subject part is viewed from the above, and “cross-sectional view” means that a cross-section of the subject part cut vertically is viewed from the side.

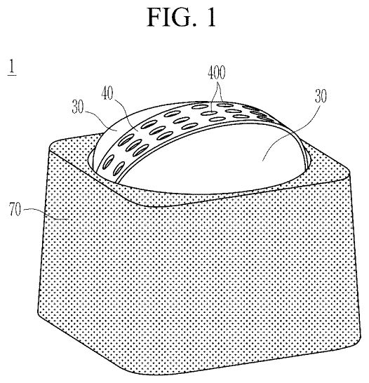

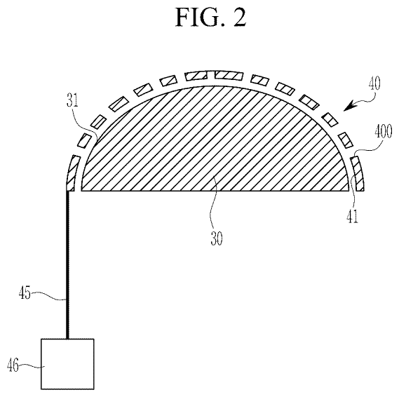

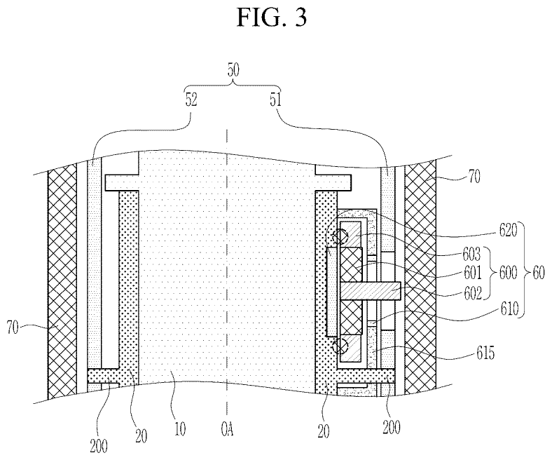

FIG. 1 shows a camera module 1 according to an embodiment, FIG. 2 is a longitudinal cross-sectional view of a light incident member 30 and a wiper 40 of FIG. 1, and FIG. 3 is a longitudinal cross-sectional view of a central area in a vertical direction of the camera module 1 of FIG. 1.

Referring to FIG. 1 to FIG. 3, a camera module 1 according to an embodiment may include a lens barrel 10, a carrier 20, a light incident member 30, a wiper 40, a supporter 50, a driving module 60, and a housing 70.

The lens barrel 10 may accommodate at least one lens. The lens barrel 10 may have a cylindrically shaped hollow space to accommodate at least one lens that images a subject therein. When a plurality of lenses are provided, the plurality of lenses may be mounted to the lens barrel 10 along an optical axis OA. The optical axis OA may be oriented in the vertical direction. A plurality of lenses are arranged in a required number according to the design of the lens barrel 10, and each lens may have optical characteristics such as the same or different refractive index.

The lens barrel 10 may transmit light incident from above downward. An upper part of the lens barrel 10 is a direction in which light is incident from the outside toward the lens barrel 10, and may be a direction in which an external subject being photographed through the camera module 1 is positioned. A lower part of the lens barrel 10 may be disposed in the camera module 1 in a direction which light passing through the lens barrel 10 forms an image. In FIG. 3, it is illustrated that the upper part of lens barrel 10 is directed toward the upper part of the drawing, and the lower part of lens barrel 10 is directed toward the lower part of the drawing. Accordingly, the upper part of the lens barrel 10 may be an upper part of the camera module 1 and the lower part of the lens barrel 10 may be a lower part of the camera module 1.

The carrier 20 may accommodate the lens barrel 10. The carrier 20 may accommodate the lens barrel 10 with a structure that contacts at least a part of an outer surface of the lens barrel 10. For example, a hole corresponding to the outer surface of the lens barrel 10 is formed in an inner center region of the carrier 20 so that the lens barrel 10 can be inserted into the carrier 20.

The light incident member 30 may be disposed at least partially above an upper end of the lens barrel 10. The light incident member 30 is exposed to the outside. The light incident member 30 is provided with a light-transmitting material and may be disposed on the optical axis OA. For example, the light incident member 30 may be transparent. Accordingly, external light may be incident into the lens barrel 10 via the light incident member 30. For example, the light incident member 30 may be the uppermost positioned lens among the at least one lens. In addition, the light incident member 30 may be provided separately from the lens and may be a lens cover disposed above the uppermost positioned lens. The light incident member 30 may be fixed to the lens barrel 10. The light incident member 30 may have a dome structure that is convex upward.

The wiper 40 may be disposed in a region where light is incident toward the lens barrel 10. The wiper 40 may be disposed above the lens barrel 10. The wiper 40 may be disposed above the light incident member 30. The wiper 40 may remove a foreign substance from an outer surface 31 of the light incident member 30 while moving with respect to the light incident member 30.

An interior side 41 of the wiper 40 facing the lens barrel 10 and the light incident member 30 may be curved corresponding to the outer surface 31 of the light incident member 30. In addition, the interior side 41 of the wiper 40 may not contact the outer surface 31 of the light incident member 30.

The interior side 41 of the wiper 40 may have a protrusions and depressions structure. For example, at least one or more holes 400 are formed in the wiper 40 so that the interior side 41 of the wiper 40 may have a protrusions and depressions structure. Accordingly, the inner side 41 of the wiper 40 exhibits a capillary effect through the protrusions and depressions structure, thereby effectively removing a foreign substance from the outer surface 31 of the light incident member 30.

In addition, the interior side 41 of the wiper 40 may be made of a hydrophilic material. For example, the interior side 41 of the wiper 40 may have hydrophilicity through a plasma treatment. In addition, the interior side 41 of the wiper 40 may be made of a hydrophilic polymer such as polyvinyl alcohol or other hydrophilic polymer, or may be coated with a hydrophilic polymer. When the interior side 41 of the wiper 40 has hydrophilicity, the foreign substance of the outer surface 31 of the light incident member 30 can be effectively removed.

In addition, a voltage application line 45 may be connected to the wiper 40. The voltage application line 45 may be connected to a power supply 46 for cleaning. The wiper 40 may be charged by a voltage applied by the cleaning power supply 46. When the wiper 40 is charged, the foreign substance on the outer surface 31 of the light incident member 30 may be removed more effectively through an attractive force generated by the charge.

The supporter 50 may support the wiper 40. One end of the supporter 50 in a length direction may be rotatably connected to a pivot pin 200. The pivot pin 200 may be connected to the carrier 20. A length direction of the pivot pin 200 may extend in a horizontal direction. The other end of the supporter 50 in the length direction may be connected to the wiper 40.

The supporter 50 may include a first supporter 51 and a second supporter 52. The first supporter 51 and the second supporter 52 may be disposed on opposite sides of the lens barrel 10. The other end of the first supporter 51 in the length direction and the other end of the second support 52 in the length direction may be respectively connected to opposite ends of the wiper 40 in a length direction of the wiper 40.

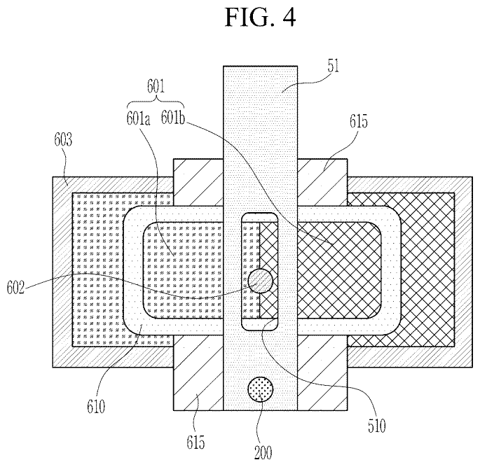

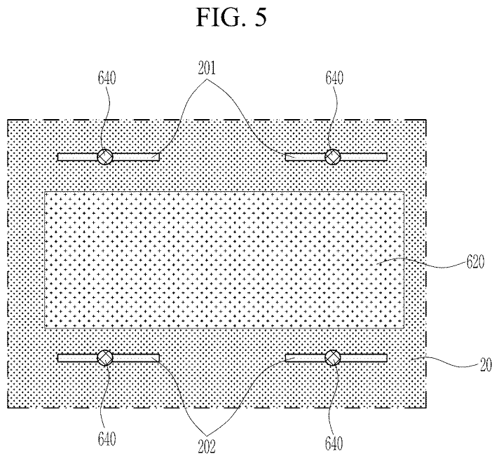

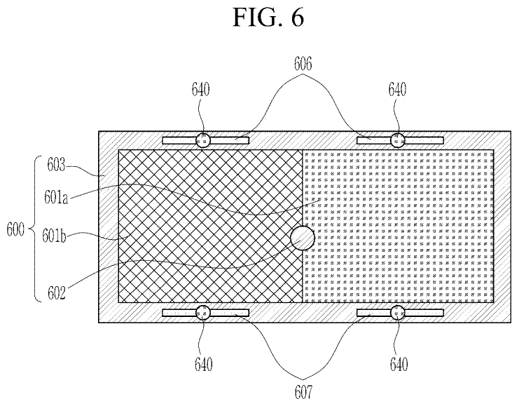

FIG. 4 shows the driving module 60 and the first supporter 51 of FIG. 3 viewed toward the lens barrel 10, FIG. 5 shows the outer surface of the carrier 20 in a region where the driving module 60 is disposed viewed toward the lens barrel 10, and FIG. 6 shows an inner surface of a driving member 600 facing the outer surface of the carrier 20 shown in FIG. 5.

Referring to FIG. 3 to FIG. 6, the driving module 60 may provide power for the wiper 40 to move with respect to the light incident member 30. The wiper 40 may be driven in a sweeping motion by the power provided by the driving module 60. The driving module 60 may provide power to rotate the first supporter 51 about the pivot pin 200. A driving member 600 may be disposed to face the first supporter 51. The driving module 60 may include the driving member 600, a coil 610, and a yoke 620.

The driving member 600 may be provided with at least some regions that are magnetic, and thus it can be moved according to a magnetic force applied from the outside. The driving member 600 includes an N-pole region 601a and an S-pole region 601b, and the N-pole region 601a and the S-pole region 601b may be arranged in a direction crossing the vertical direction. For example, the N-pole region 601a and the S-pole region 601b may be arranged in the horizontal direction. A part of the driving member 600 is inserted into the first supporter 51 to be slidably movable.

An inner surface of the driving member 600 may face an outer surface of the carrier 20. An outer surface of the driving member 600 may be face away from the lens barrel 10 and the carrier 20. Ball bearings 640 may be disposed between the driving member 600 and the carrier 20.

The driving member 600 may include a magnetic member 601, a guide pin 602, and a supporting member 603.

The magnetic member 601 may be magnetic. The magnetic member 601 may include an N-pole region 601a and an S-pole region 601b.

The guide pin 602 may be disposed to protrude a predetermined length outward from the outer surface of the driving member 600. For example, an inner end of the guide pin 602 facing the lens barrel 10 and the carrier 20 may be inserted into and fixed to the magnetic member 601. The inner end of the guide pin 602 may be connected to the magnetic member 601 in a region where the N-pole region 601a and the S-pole region 601b meet. A sliding hole 510 may be formed in the first supporter 51. The sliding hole 510 may have a slit shape having a predetermined length in the length direction of the first supporter 51. The guide pin 602 may be inserted into the sliding hole 510. During the operation of the driving module 60, the guide pin 602 may slide within the sliding hole 510.

The supporting member 603 may be disposed in at least some region of an outer circumference of the magnetic member 601. For example, the supporting member 603 may be disposed above the top and below the bottom of the magnetic member 601. In addition, the supporting member 603 may be provided to surround the outer circumference of magnetic member 601. That is, the supporting member 603 is provided as a ring structure corresponding to the outer circumference of the magnetic member 601, and thus the magnetic member 601 may be inserted into the inner side of the supporting member 603.

At least one of inner guide grooves 606 and 607 may be formed on the inner surface of the driving member 600. Length directions of the inner guide grooves 606 and 607 may extend in the horizontal direction.

The inner guide grooves 606 and 607 may include a first inner guide groove 606 and a second inner guide groove 607.

The first inner guide groove 606 may be formed in an upper inner surface of the driving member 600. The first inner guide groove 606 may be formed in a region of the inner surface of the supporting member 603 disposed above the magnetic member 601. The first inner guide groove 606 may be formed across a region disposed above the N-pole region 601a and above the S-pole region 601b. In this case, the first inner guide groove 606 may have portions disposed above the N-pole region 601a and above the S-pole region 601b that are connected to each other. Alternatively, the first inner guide groove 606 may have portions disposed above the N-pole region 601a and above the S-pole region 601b that are disconnected from each other. FIG. 6 illustrates an example in which portions of the first inner guide groove 606 disposed above the N-pole region 601a and above the S-pole region 601b are disconnected from each other.

The second inner guide groove 607 may be formed in a lower inner surface of the driving member 600. The second inner guide groove 607 may be formed in a region of the inner surface of the supporting member 603 disposed below the magnetic member 601. The second inner guide groove 607 may be formed across a region disposed below the N-pole region 601a and below the S-pole region 601b. In this case, the second inner guide groove 607 may have portions disposed below the N-pole region 601a and below the S-pole region 601b that are connected to each other. Alternatively, the second inner guide groove 607 may have portions disposed below the N-pole region 601a and below the S-pole region 601b that are disconnected from each other. FIG. 6 illustrates an example in which portions of the second inner guide groove 607 disposed below the N-pole region 601a and below the S-pole region 601b are disconnected from each other.

The coil 610 forms a magnetic field around it by the applied electric power, and the interaction between the magnetic field and the driving member 600 causes the driving member 600 to move. The coil 610 is spaced apart from the outer surface of the driving member 600, and thus it may be disposed facing the outer surface of the driving member 600. That is, the driving member 600 may be disposed between the carrier 20 and the coil 610. The coil 610 is provided in a ring shape, and thus the guide pin 602 may be disposed for insertion into the inner space of the coil 610. The coil 610 may be fixed in position relative to the lens barrel 10 and the carrier 20 by a coil fixing member 615. For example, the coil 610 may be connected to the carrier 20 by the coil fixing member 615.

The yoke 620 is disposed to face at least a part region of the inner surface of the driving member 600. The yoke 620 may be disposed to face the inner surface of the magnetic member 601. The position of the yoke 620 may be fixed. The yoke 620 may be connected to the carrier 20. For example, at least a part of the yoke 620 may be fixed to the carrier 20 by inserting the yoke 620 in the carrier 20. The yoke 620 is made of a material that generates a magnetic attraction with the driving member 600, and thus a magnetic attraction occurs between the yoke 620 and the driving member 600. For example, the yoke 620 may be made of a metal material that is a magnetic material.

An outer surface of the carrier 20 and the inner surface of the driving member 600 may be spaced apart from each other. In addition, an outer surface of the yoke 620 and the inner surface of the driving member 600 may be spaced apart from each other. At least one of outer guide grooves 201 and 202 may be formed in the outer surface of the carrier 20. A length direction of the outer guide grooves 201 and 202 may extend in a horizontal direction.

The outer guide grooves 201 and 202 may include a first outer guide groove 201 and a second outer guide groove 202.

The first outer guide groove 201 may be disposed above the yoke 620. The first outer guide groove 201 may be positioned at a height corresponding to a height of the first inner guide groove 606. A distance between opposite ends of the first outer guide groove 201 in the horizontal direction may be equal to a distance between opposite ends of the first inner guide groove 606 in the horizontal direction. Regions of the first inner guide groove 606 disposed at opposite sides in the horizontal direction may be connected to each other. Alternatively, regions of the first inner guide groove 606 disposed at opposite sides in the horizontal direction may be disconnected from each other. In FIG. 5, a case in which regions of the first outer guide groove 201 disposed at opposite sides in the horizontal direction are disconnected from each other is illustrated.

The second outer guide groove 202 may be disposed below the yoke 620. The second outer guide groove 202 may be positioned at a height corresponding to a height of the second inner guide groove 607. A distance between opposite ends of the second outer guide groove 202 in the horizontal direction may be equal to a distance between opposite ends of the second inner guide groove 607 in the horizontal direction. Regions of the second inner guide groove 607 disposed at opposite sides in the horizontal direction may be connected to each other. Alternatively, regions of the second inner guide groove 607 disposed at opposite sides in the horizontal direction may be disconnected from each other. In FIG. 6, a case in which regions of the second outer guide groove 202 disposed at opposite sides in the horizontal direction are disconnected from each other is illustrated.

The ball bearings 640 may be disposed between the inner guide grooves 606 and 607 and the outer guide grooves 201 and 202. Some of the ball bearings 640 may be disposed between the first inner guide groove 606 and the first outer guide groove 201. These ball bearings 640 may be disposed in regions at opposite sides of the first inner guide groove 606 and opposite sides of the first outer guide groove 201 in the horizontal direction.

In addition, some of the ball bearings 640 may be disposed between the second inner guide groove 607 and the second outer guide groove 202. These ball bearing 640 may be disposed in regions at opposite sides of the second inner guide groove 607 and opposite sides of the second outer guide groove 202 in the horizontal direction.

For better understanding and ease of description, FIG. 5 shows the ball bearings 640 disposed in the outer guide grooves 201 and 202, and FIG. 6 shows these same ball bearings 640 disposed in the inner guide grooves 606 and 607.

The attractive force acting between the yoke 620 and the driving member 600 can prevent the driving member 600 from falling away from the yoke 620. In addition, the outer surface of the yoke 620 and the inner surface of the driving member 600 are prevented from sticking to each other by the ball bearings 640. Accordingly, the driving member 600 can be effectively moved by the magnetic force generated by the coil 610. In addition, the driving member 600 can be effectively moved in the horizontal direction relative to the carrier 20 and the coil 610 by the inner guide grooves 606 and 607, the outer guide grooves 201 and 202, and the ball bearings 640.

The housing 70 surrounds the lens barrel 10, the carrier 20, and the driving module 60. In addition, the supporter 50 may be disposed inside the housing 70.

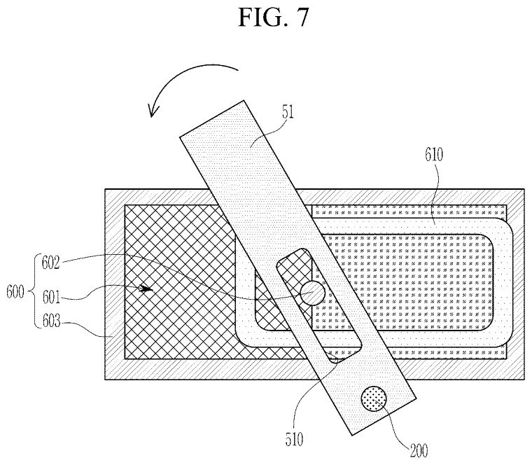

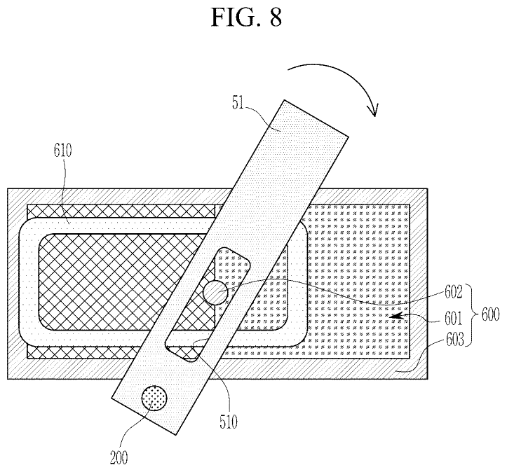

FIG. 7 and FIG. 8 show operation states of the driving module 60.

Referring to FIG. 7 and FIG. 8, electric power may be applied to the coil 610 of the driving module 60. The electric power applied to the coil 610 may be supplied from a vehicle, an electronic device, or other apparatus in which the camera module 1 is installed. The electric power applied to coil 610 is provided in alternating current (AC) form, and thus an AC current may flow through the coil 610. Accordingly, a magnetic field generated around the coil 610 changes in magnitude and direction. Thus, when the magnetic field is formed in one direction around the coil 610, the driving member 600 may move to the left with respect to the coil 610 due to the force acting between the magnetic field and the magnetic member 601 of the driving member 600 as shown in FIG. 7. During this process, the first supporter 51 may be rotated to the left as the guide pin 602 moves to the left.

In addition, when the direction of the magnetic field formed around the coil 610 is opposite to the case shown in FIG. 7, the driving member 600 may move to the right with respect to the coil 600 as shown in FIG. 8 due to the force acting between the magnetic field and the magnetic member 601 of the driving member 600. During this process, the first supporter 51 may be rotated to the right as the guide pin 602 moves to the right.

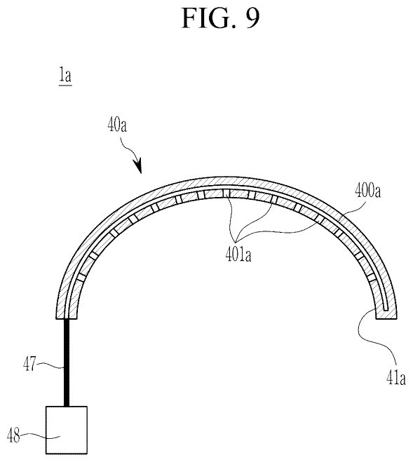

FIG. 9 is a cross-sectional view of a wiper 40a of a camera module 1a according to another embodiment.

Referring to FIG. 9, a cleaning fluid path 400a may be formed inside the wiper 40a. A plurality of fluid discharge holes 401a may be formed in an inner surface 41a of the wiper 40a. The fluid discharge holes 401a may be connected to the cleaning fluid path 400a. The cleaning fluid path 400a may be connected with a cleaning fluid supply member 48 through a connection line 47. The cleaning fluid supply member 48 may supply a cleaning fluid. The cleaning fluid supply member 48 may be disposed in a vehicle, an electronic device, other apparatus in which the camera module 1a is installed. The cleaning fluid may be a cleaning gas such as air, or a cleaning liquid. The cleaning fluid sprayed from the wiper 40a may perform cleaning by spraying the cleaning fluid toward the outer surface 31 of the light incident member 30 described above.

In addition, the wiper 40a may be made of a transparent material. For example, the wiper 40a may be made of a transparent polymer or other transparent material. Accordingly, even when the wiper 40a is disposed outside the outer surface 31 of the light incident member 30, light can be effectively incident onto the light incident member 30.

According to at least one of the embodiments of the present disclosure, a camera module that can effectively remove a foreign substance attached to a region onto which light is incident can be provided.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens barrel;
a wiper disposed in a region in which light is incident toward the lens barrel;
a supporter connected to the wiper; and
a driving module configured to provide power to rotate the supporter,
wherein the driving module comprises:
a driving member having a magnetic property and comprising a part inserted into the supporter and being slidingly movable relative to the supporter; and
a coil configured to generate a magnetic field to move the driving member.

2. The camera module of claim 1, wherein a sliding hole having a predetermined length is formed in the supporter in a length direction of the supporter, and
the driving member comprises:
a magnetic member comprising an N-pole region and an S-pole region; and
a guide pin connected to the magnetic member, inserted into the coil and the sliding hole, and being slidingly movable in the sliding hole relative to the supporter.

3. The camera module of claim 1, wherein the coil is disposed at a fixed position relative to the lens barrel.

4. The camera module of claim 1, further comprising a carrier accommodating the lens barrel.

5. The camera module of claim 4, wherein the driving module further comprises a yoke connected to the carrier and configured to generate a magnetic attraction with the driving member.

6. The camera module of claim 5, further comprising at least one ball bearing disposed between the carrier and the driving member.

7. The camera module of claim 6, wherein an outer guide groove is formed in the carrier, and
the at least one ball bearing is disposed in the outer guide groove.

8. The camera module of claim 6, wherein an inner guide groove is formed in the driving member, and
the at least one ball bearing is disposed in the inner guide groove.

9. The camera module of claim 1, further comprising a voltage application line connected to the wiper.

10. The camera module of claim 1, wherein an inner surface of the wiper facing the lens barrel has hydrophilicity.

11. The camera module of claim 1, wherein an inner surface of the wiper facing the lens barrel has a protrusions and depressions structure.

12. The camera module of claim 1, wherein a cleaning fluid path is formed in the wiper, and
a fluid discharge hole connected to the cleaning fluid path is formed in an inner surface of the wiper facing the lens barrel.

13. The camera module of claim 1, wherein the wiper is comprises a transparent material.

14. The camera module of claim 1, further comprising a light incident member of which at least a portion is disposed above an upper end of the lens barrel,
wherein the wiper does not contact the light incident member.
